(19) United States
(12) Patent Application Publication
(10) Pub. No.: US 2006/0045562 A1
(43) Pub. Date: Mar. 2, 2006

(54) Shock absorbing apparatus for packaging toner cartridge

(75) Inventors: Jai-Il Choi, Suwon-si (KR); Myung-Sun Cha, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/106,457

(22) Filed: Apr. 15, 2005

(30) Foreign Application Priority Data
Aug. 27, 2004 (KR) 2004-68170

(51) Int. Cl. G03G 15/08

(52) U.S. Cl. 399/103

(57) ABSTRACT

A shock absorbing apparatus for packaging a toner cartridge includes first shock absorbing members inserted onto both ends of the toner cartridge and having a groove at least partially in contact with lower and upper surfaces of the toner cartridge, a second shock absorbing member located under a center portion of the toner cartridge to support the center portion of the toner cartridge, and a box, in which the toner cartridge inserted into the first and second shock absorbing members is packaged. The shock absorbing apparatus is capable of reducing manufacturing costs since it is no longer necessary to use an expensive, specially designed package to transport individually packaged toner cartridges, minimizing leakage of the developing agent. Still further, the shock absorbing apparatus is capable of preventing the toner cartridge from being contaminated as a whole since the leaked developing agent can be absorbed by the protection pad and the protection sheet even when the developing agent leaks during its distribution. The toner cartridge is kept substantially clean during its distribution since the contaminated parts are wiped by the protection pad.

### CROSS-REFERENCE TO RELATED APPLICATION

This application claims the benefit under 35 U.S.C. §119(a) of Korean Patent Application No. 2004-68170, filed Aug. 27, 2004, the entire contents of which is expressly incorporated herein by reference.

### BACKGROUND OF THE INVENTION

1. Field of the Invention

The present invention relates to packaging for a toner cartridge. More particularly, the present invention relates to a shock absorbing apparatus used to safely transport a toner cartridge used in a static type image forming apparatus during its distribution.

2. Description of the Related Art

Static type image forming apparatuses, such as a laser printer, have the advantages of rapid print speed, high quality printing, and low maintenance costs. Therefore, static type apparatuses have been widely used by companies or personal users requiring a large amount of printing operation.

The static type image forming apparatus employs the method of irradiating light, such as a laser beam, onto a photosensitive drum to form a static latent image, applying and developing a developing agent, such as a toner, to the surface of the photosensitive drum using a supply roller and a developing roller, transferring the latent image to a recording medium, such as paper, and settling it to output the printed matter. The developing agent, photosensitive drum and the like generally have a shorter lifetime than that of the image forming apparatus, and should be periodically exchanged or replaced.

Recently, a series of parts, such as the developing agent and the photosensitive drum, have been fabricated as an integrated module. This makes it easier for service personnel or a general user to exchange the developing agent and drum when they are worn or broken, and require replacement.

Referring to FIG. 1, an example of a conventional toner cartridge is illustrated. A housing of the toner cartridge may be divided into an upper frame 10, that functions as a cover of the toner cartridge, and a lower frame 12, that supports various parts and provides storage space for the developing agent. The upper frame 10 is provided with a handle 14 for easily gripping the toner cartridge in its central rear portion. The lower frame 12 is provided with a storage space 16 for storing the developing agent, and a supply roller 18 for supplying the developing agent to a developing roller 20. The supply roller 18 is installed at the left side of the storage space 16, as viewed in FIG. 1. The developing agent supplied from the supply roller 18 is applied to a surface of the developing roller 20, and a doctor blade 22 is installed adjacent to the developing roller 20 to control the thickness of the developing agent as it is applied to the developing roller 20.

A photosensitive roller 24 is installed adjacent to the developing roller 20. A static latent image is formed on the surface of the photosensitive drum 24 by a laser beam, and the developing agent is applied onto the static latent image to develop the image. The photosensitive drum 24 is electrically charged by a charge roller 26.

In the aforementioned toner cartridge, as sometimes happens, the developing agent may easily leak to the exterior since it is made of fine particles. The outer surface of the storage space 16 of the developing agent is hermetically sealed with a sealing material. During operation of the image forming apparatus, a portion of the developing agent developed at the surface of the photosensitive drum during the developing process flows back to the supply roller to be reused. In order to prevent leakage of the refilled developing agent, a film 28 is attached to the lower frame 12 to perform additional sealing. The film 28 is a very thin film in order to prevent the toner attached on the developing roller from separating.

When the toner cartridge is damaged during shipping, the upper and lower frames formed of a plastic resin have a high probability of leaking the developing agent due to deformation of the frames. Therefore, in the conventional art, as shown in FIGS. 2 and 3, the toner cartridge is inserted into shock absorbing members 30 at both ends thereof to be packaged in a box and transported. Each of the shock absorbing members 30 is provided with protrusions 32 at its surfaces in contact with inner surfaces of the box. Therefore, although the box is impacted during the distribution by dropping the box, the shock absorbing members 30 may partially absorb the impact to protect the toner cartridge.

Generally, the toner cartridge is individually packaged in a box, and four to eight boxes are loaded into a larger container and then shipped. Commercial shipping and distributors rarely drop the larger containers that contain the individually boxed toner cartridges. Thus, it is unusual that the larger containers are damaged enough to excessively leak the developing agent.

Because of the increase in on-line sales individually packaged boxes of the toner cartridges are more frequently shipped. As a result, the probability of leaking the developing agent due to impact has increased in comparison with the cases of transporting the larger containers that contain a plurality of smaller boxes. If the individually packaged toner cartridge is dropped, the plurality of rollers installed at the toner cartridge are fixed to the shock absorbing members at both ends, and the impact around both ends may be somewhat absorbed by the shock absorbing members. The center portion of the toner cartridge, however, which is not protected by the shock absorbing members, has a greater chance of being deformed, thereby increasing the probability of leaking the developing agent.

### SUMMARY OF THE INVENTION

In order to solve the foregoing and/or other problems, it is an aspect of the present invention to provide means for packaging a toner cartridge capable of preventing a developing agent from leaking by effectively absorbing the impact applied to a center as well as both ends of the toner cartridge when an individually packaged toner cartridge is impacted. It is another aspect of the present invention to provide means for packaging a toner cartridge capable of maintaining a clean toner cartridge without contamination of other parts of the toner cartridge when a small amount of developing agent leaks.

The foregoing and/or other aspects of the present invention can be achieved by providing means for packaging a toner cartridge of an image forming apparatus that comprises first shock absorbing members inserted into both ends of the toner cartridge and having a groove at least partially in contact with lower and upper surfaces of the toner cartridge, a second shock absorbing member located under a center portion of the toner cartridge to support the center portion of the toner cartridge, and a box, in which the toner cartridge inserted into the first and second shock absorbing members is packaged.

The shock absorbing packaging according to an embodiment of the present invention provides the second shock absorbing member located at the center portion of the toner cartridge as well as the first shock absorbing members inserted into the both ends of the toner cartridge to enable the members to uniformly absorb an impact all over the toner cartridge. The first and second shock absorbing members can include protrusions protruded from their outer surfaces to be in contact with inner surfaces of the box.

According to an exemplary embodiment of the present invention, after the toner cartridge is packed in a sealing bag made of a synthetic resin, the toner cartridge is supported by the first and second shock absorbing members. The sealing bag can be made of a flexible material. A portion where a charge roller and a photosensitive drum are located is referred to as a front portion, and an opposite side is referred to as a rear portion, with reference to the center portion of the toner cartridge. The second shock absorbing member can either support all of upper and lower surfaces and front and rear surfaces, or support only a portion of the surfaces. For example, the second shock absorbing member can include a base part for supporting a bottom surface of the toner cartridge, and a vertical part for supporting a front portion of the toner cartridge. In addition, a plurality of second shock absorbing members can also be used.

According to an exemplary embodiment of the present invention, when the toner cartridge is packaged into the box, a gap exists between the base part and the bottom surface of the toner cartridge. Therefore, when the box, in which the toner cartridge is packaged, is pressed by external force, it becomes possible to prevent excessive pressure from applying to the center portion by virtue of the gap. Furthermore, a flexible protection pad can be additionally installed at the bottom surface of the toner cartridge corresponding to the gap. The protection pad, which is positioned at the bottom surface of the toner cartridge, can be packed in the sealing bag according to an exemplary embodiment of the present invention. Therefore, the protection pad can be stably fixed to the toner cartridge without individual fixing means, and the developing agent leaked from the toner cartridge is partially absorbed into the protection pad to prevent the toner cartridge from being contaminated as a whole.

According to an exemplary embodiment of the present invention, the protection pad has a thickness larger than the gap and a hardness lower than that of the second shock absorbing member to allow the second shock absorbing member to secondarily absorb the impact, after the protection pad primarily absorbs the impact when pressure is applied to the box. A protective sheet can be attached to a surface of the protection pad to prevent the developing agent stored in the protection pad from leaking outside the box.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a cross-sectional view illustrating a conventional toner cartridge;

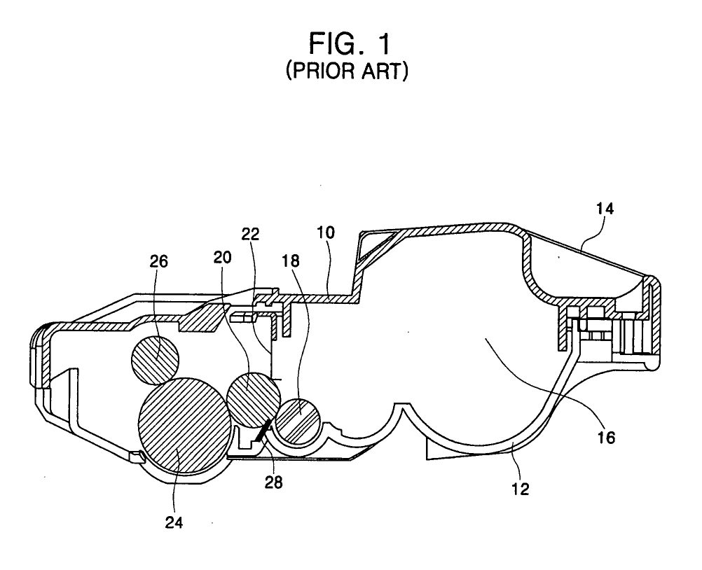

FIG. 2 is a side view illustrating the conventional toner cartridge with a shock absorbing member located at an end of the conventional toner cartridge;

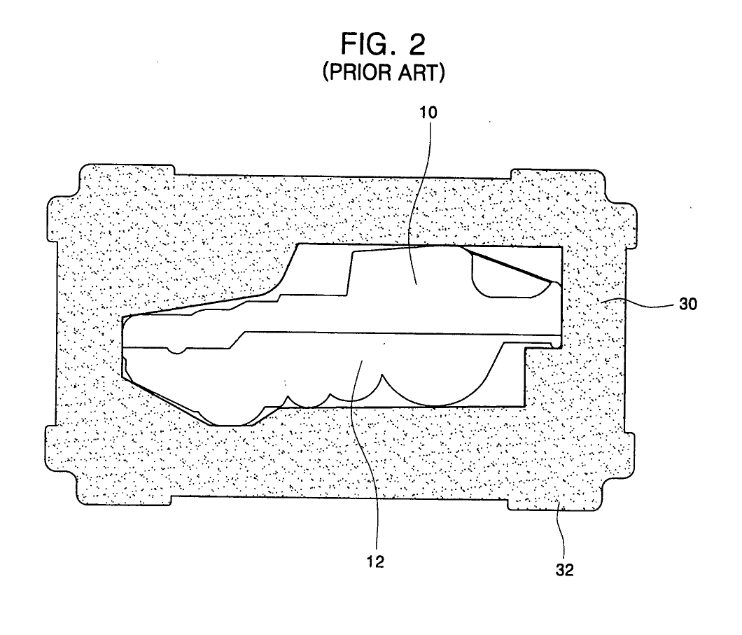

FIG. 3 is a perspective view illustrating the conventional toner cartridge with shock absorbing members inserted at both ends of the conventional toner cartridge;

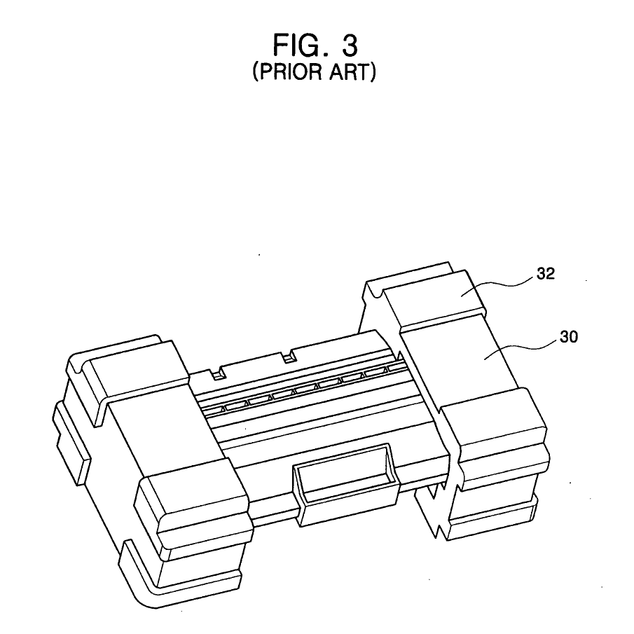

FIG. 4 is an exploded perspective view illustrating a packaging apparatus for packaging a toner cartridge in accordance with an embodiment of the present invention;

FIG. 5 is a perspective view illustrating the embodiment shown in FIG. 4;

FIG. 6 is a side view illustrating the embodiment shown in FIG. 4; and

FIG. 7 is a plan view illustrating the embodiment shown in FIG. 4 inserted into a box.

### DETAILED DESCRIPTION OF THE INVENTION

Several embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein have been omitted for conciseness and clarity.

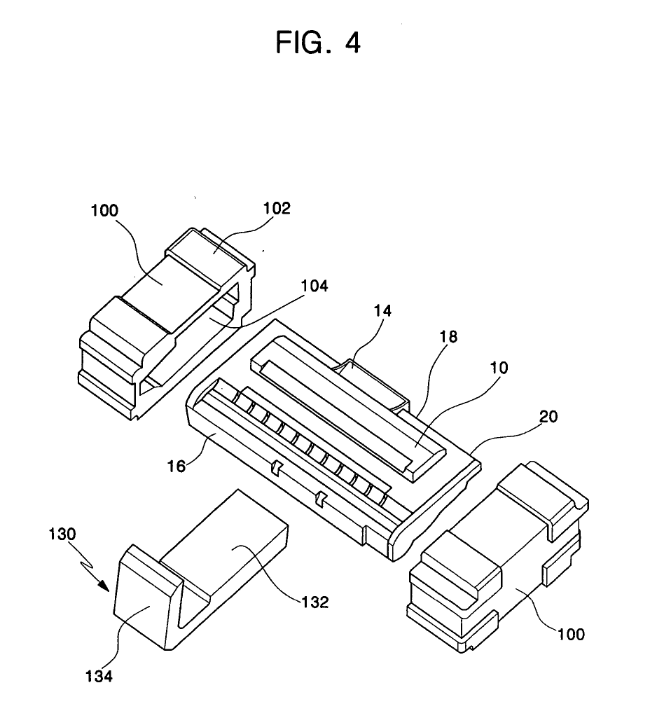

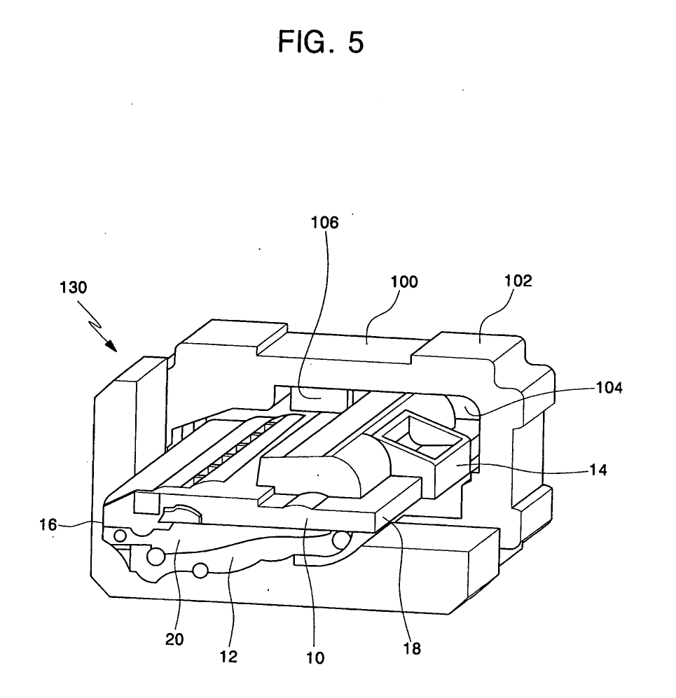

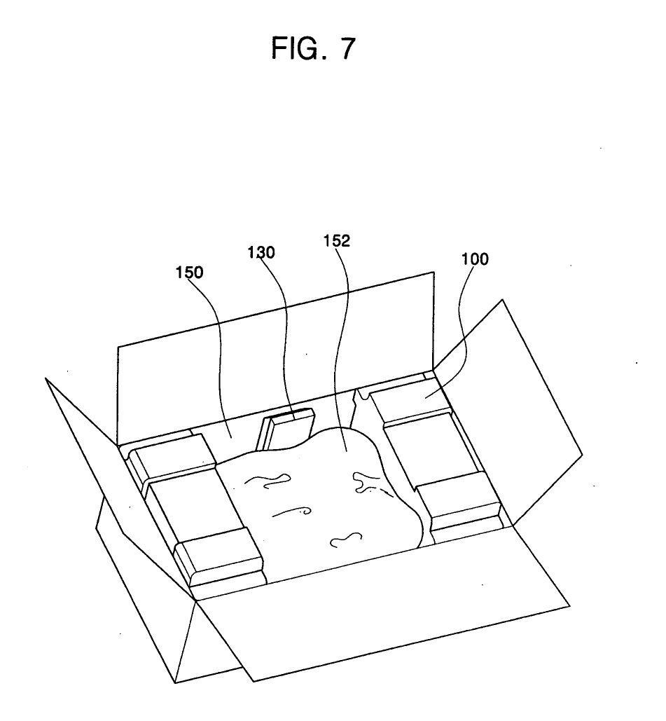

Referring to FIG. 4, a toner cartridge 20 includes an upper frame 10 having a handle 14, and a lower frame 12 (referring to FIG. 5) located under the upper frame 10. Meanwhile, first shock absorbing members 100 are inserted into both ends of the toner cartridge 20. Each of the first shock absorbing members 100 has an approximately rectangular shape, and each corner of the member 100 is provided with a pair of protrusions 102 in contact with inner surfaces of a box 150 (referring to FIG. 7) to support the shock absorbing member 100. The thickness of the shock absorbing member 100 varies depending upon the position of the protrusions 102. A portion of the protrusions 102, which are in contact with the box 150 to resist impacts, thereby more effectively absorb the impact, although the same amount of material is used.

In addition, the first shock absorbing member 100 has a groove 104 for inserting an end section of the toner cartridge 20. The groove 104 has a shape corresponding to the end section of the toner cartridge 20. As FIG. 4 illustrates, the groove 104 is formed to be partially in contact with a front portion 16, the upper frame 10, the lower frame 12, and a rear portion 18 of the toner cartridge. Since the toner cartridge 20 has an external shape having a plurality of surfaces and protrusions, it is difficult to make all surfaces of the toner cartridge 20 be in contact with the shock absorbing members 100, and the simple structure of the groove allows the shock absorbing members 100 to be more easily inserted and disassembled.

According to an embodiment of the present invention, a second shock absorbing member 130 is disposed at or near the center of the toner cartridge 20. The second shock absorbing member 130 is formed to be in contact with the front portion 16 and the lower frame 12 of the toner cartridge 20, but not the upper frame 10 or rear portion 18. The second shock absorbing member 130 is therefore not fixed to the toner cartridge 20 by itself, but located in the bottom of the box 150 and the toner cartridge 20 with first shock absorbing members 100 is placed on top of it.

The second shock absorbing member 130 is located parallel to the lower frame of the toner cartridge 20, and includes a base part 132 for supporting the lower frame 12 of the toner cartridge 20 and a vertical part 134 located at one end of the base part 132 to support the front portion 16 of the toner cartridge 20. The vertical part 134 extends upward from the base part 132. Therefore, the second shock absorbing member 130 supports the toner cartridge 20 at two separate surfaces; the front portion 16 and lower frame 12.

FIG. 5 is a perspective view illustrating the toner cartridge 20, which is inserted into the first and second shock absorbing members 100 and 130. As shown in FIG. 5, a presser 106 is formed at an upper portion of the groove 104 of the first shock absorbing member 100 to press the toner cartridge 20 toward the base part 132 of the second shock absorbing member 130. Therefore, the toner cartridge 20 is in contact with the second shock absorbing member 130 by the presser 106.

FIG. 7 illustrates the toner cartridge 20 hermetically sealed in a sealing bag 152 made of a polyethylene material and inserted into the shock absorbing members 100, 130, and then packaged in a box 150. The toner cartridge 20 is inserted into the sealing bag 152 made of the polyethylene material, an inlet of the sealing bag is fusion-bonded to be hermetically sealed, and then the toner cartridge is packaged in the box 150.

If the packaged box 150 is pressed by an external force (i.e., from being dropped or something being dropped on it), the pressure is transmitted to the first shock absorbing members 100 located at the both ends of the toner cartridge to press both ends of the toner cartridge 20 toward the bottom of the box 150. If an excessive amount of force is applied to the top of the box 150 that contains the toner cartridge 20 supported by first and second shock absorbing members 100, 130, the lower frame 12 of the toner cartridge 20 will flex and bow about the second shock absorbing member 130. While the developing agent may not leak from the toner cartridge 20, the deformed lower frame 12 may cause deformation of the roller mounted in the toner cartridge 20. Therefore, it is preferable to prevent the lower frame 12 from deforming by the second shock absorbing member 130 when the pressure is applied to the box 150, by providing a predetermined gap between the second shock absorbing member 130 and the lower frame 12 of the toner cartridge.

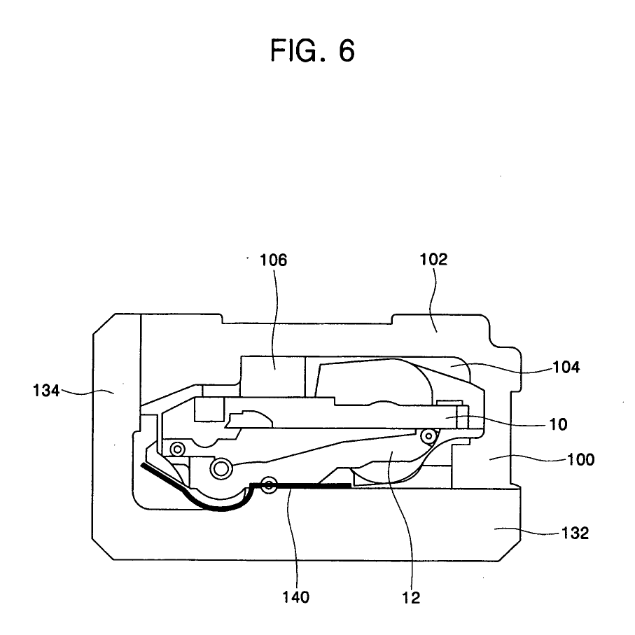

If a gap exists between the second shock absorbing member 130 and the lower frame 12, however, the second shock absorbing member 130 loses its supporting function to the center of the toner cartridge 20. Therefore, a protection pad 140 having a hardness lower than that of the second shock absorbing member 130 is inserted into the gap, as shown in FIG. 6. The protection pad 140 can be employed in the form of a sponge, and can be directly attached to the surface of the second shock absorbing member 130. According to an exemplary embodiment of the present invention, the shock absorbing member 130 can be inserted into the sealing bag 152.

There is no need to individually fix the location of the protective pad 140 if it is installed in the sealing box 152 before the toner cartridge 20 is inserted. The installer can manually locate the protective pad 140 in the desired location and insert the hermetically sealed toner cartridge 20 with the first shock absorbing members 100 onto the previously located second shock absorbing member 130. In order to improve the fix strength, the protection pad 140 and the toner cartridge can be inserted together after the protection pad 140 and the lower frame 12 of the toner cartridge are adhered to each other using an adhesive tape. Since the protection pad 140 is made of a porous material (e.g. a sponge, among other types of materials), a small amount of developing agent leaked during its transportation can be absorbed into the sponge to prevent the toner cartridge 20 from being contaminated as a whole. In an exemplary embodiment of the present invention, when the protection pad 140 is provided with a protection sheet made of paper, the developing agent that leaks from the toner cartridge 20 is substantially absorbed by the protection pad 140 and the protection sheet. The protection pad 140 can also be used to wipe off developing agent when the other parts are contaminated. Therefore, the protection pad 140 has a width equal to or larger than that of the toner cartridge.

According to an embodiment of the present invention, when the gap between the lower frame 12 and the second shock absorbing member 130 is about 2 mm, and the protection pad 140 has a thickness of about 6 mm, the ability to absorb shock is optimized. When the gap has a width larger than about 5 mm, the thickness of the protection pad 140 is correspondingly increased, but the shock absorbing effect decreases, thereby increasing leakage of the developing agent. According to other embodiments of the present invention, disposition of a pair of second shock absorbing members can be used to absorb shock and leaked developing agent.

As can be seen from the foregoing, the present invention has the advantage of reducing manufacturing costs since it is no longer necessary to use an expensive, specially designed package even when an individually packaged toner cartridge is transported. Furthermore, leakage of the developing agent is substantially minimized. In addition, the shock absorbing apparatus of the present invention is capable of substantially preventing the toner cartridge 20 from being contaminated as a whole since the leaked developing agent can be absorbed by the protection pad 140 and the protection sheet even when the developing agent leaks during shipping. The toner cartridge 20 remains clean during its distribution since the protection pad 140 keeps the toner cartridge 20 and interior of the box 150 clean by substantially absorbing all the leaked toner cartridge.

Although several embodiments of the present invention have been shown and described, it will be appreciated by those skilled in the art that changes may be made in these embodiments without departing from the principles and spirit of the invention, the scope of which defined in the appended claims.

1. A shock absorbing apparatus for packaging a toner cartridge of an image forming apparatus, comprising:
first shock absorbing members inserted onto both ends of the toner cartridge and having a groove at least partially in contact with lower and upper surfaces of the toner cartridge;
a second shock absorbing member located under a center portion of the toner cartridge to support the center portion of the toner cartridge; and
a box, in which the toner cartridge inserted into the first and second shock absorbing members is packaged.

2. The shock absorbing apparatus according to claim 1, wherein the first and second shock absorbing members comprise protrusions protruding from their outer surfaces to be in contact with inner surfaces of the box.

3. The shock absorbing apparatus according to claim 1, further comprising:
a sealing bag made of a synthetic resin for packing the toner cartridge, and wherein, the toner cartridge is supported by the first and second shock absorbing members.

4. The shock absorbing means apparatus according to claim 1, wherein the second shock absorbing member comprises:
a base part for supporting a bottom surface of the toner cartridge;
and a vertical part for supporting a front portion of the toner cartridge.

5. The shock absorbing apparatus according to claim 4, further comprising:
a gap that exists between the base part and the bottom surface of the toner cartridge when the toner cartridge is packaged in the box.

6. The shock absorbing apparatus according to claim 5, further comprising:
a flexible protection pad installed at the bottom surface of the toner cartridge corresponding to the gap.

7. The shock absorbing apparatus according to claim 6, wherein the protection pad, which is positioned at the bottom surface of the toner cartridge, is packed in the sealing bag together with the toner cartridge.

8. The shock absorbing apparatus according to claim 6, wherein the protection pad has a thickness larger than the gap and a hardness lower than that of the second shock absorbing member.

9. The shock absorbing apparatus according to claim 6, further comprising:
a protective sheet for attaching to one surface of the protection pad.

10. The shock absorbing apparatus according to claim 1, wherein the second shock absorbing member is formed to support a front portion and a bottom surface of the toner cartridge.

11. The shock absorbing apparatus according to claim 1, further comprising:
a plurality of second shock absorbing members for respectively supporting surfaces of the toner cartridge.

12. The shock absorbing apparatus according to claim 1, further comprising:
a gap formed between the toner cartridge and the second shock absorbing member.

13. The shock absorbing apparatus according to claim 12, further comprising:
a flexible protection pad installed at the bottom surface of the toner cartridge corresponding to the gap.

14. The shock absorbing apparatus according to claim 13, wherein the flexible protection pad, which is positioned at the bottom surface of the toner cartridge, is packed in the sealing bag together with the toner cartridge.

15. The shock absorbing apparatus according to claim 13, wherein the flexible protection pad comprises a thickness larger than the gap and a hardness lower than that of the second shock absorbing member.

16. The shock absorbing apparatus according to claim 13, further comprising:
a protective sheet attached to one surface of the protection pad.
